(19) United States
(12) Patent Application Publication
(10) Pub. No.: US 2015/0121248 A1
(43) Pub. Date: Apr. 30, 2015

(54) SYSTEM FOR EFFECTIVELY COMMUNICATING CONCEPTS

(71) Applicants: Jonathan Levin, Newton, MA (US); Tapz Communications, LLC, Needham, MA (US)

(72) Inventors: Nancy Levin, Steamboat Springs, CO (US); Kevin P. King, Steamboat Springs, CO (US)

(73) Assignee: Tapz Communications, LLC, Needham, MA (US)

(21) Appl. No.: 14/523,812

(22) Filed: Oct. 24, 2014

Related U.S. Application Data
(60) Provisional application No. 61/895,111, filed on Oct. 24, 2013.

(51) Int. Cl. H04L 12/58; G06F 3/0482; G06F 3/0488; G06F 3/0484; G06F 17/30

(52) U.S. Cl. CPC H04L 51/10; G06F 3/04842; G06F 17/30634; G06F 3/04886; G06F 3/0482
USPC 715/752

(57) ABSTRACT

Described herein are various examples of systems and methods to aid effectively communicating a meaning. In some embodiments, content units may be provided to a user of a system to assist that user in communicating a meaning. Each of the content units may be suggestive of a single concept and will be understood by a viewer to suggest that single concept. Any suitable concept may be conveyed by such a content unit, as embodiments are not limited in this respect. In some cases, some or all of the content units may be suggestive of an emotion and intended to trigger the emotion in a person viewing or listening to the content unit, such that a conversation partner receiving the content unit will feel the emotion when viewing or listening to the content unit or understand that the sender is feeling that emotion.

### CROSS REFERENCE TO RELATED APPLICATIONS

The present application claims priority under 35 U.S.C. §119(e) to U.S. Provisional Patent App. Ser. No. 61/895,111, titled “System for effectively communicating concepts” and filed on Oct. 24, 2013, the entire contents of which are hereby incorporated by reference herein.

### SUMMARY

In one embodiment, there is provided a method of operating an interpersonal messaging system. The interpersonal messaging system enables a user to exchange messages with one or more other users in a communication session, in which at least some of the messages comprise text. The method comprises displaying, via a user interface, a keyboard of a set of media content units available for inclusion in messages transmitted via the interpersonal messaging system. Each media content unit comprises audio and/or visual content and is associated with at least one unit of metadata describing a content of the media content unit. One or more of the at least one unit of metadata for each media content unit describes the content identifies a concept expressed by the media content unit and/or an emotion to be triggered in a person viewing or listening to the media content unit. Displaying the keyboard comprises displaying an array of images, and each image of the array is associated with one of the set of media content unit. The method further comprises, in response to a single input of a user indicating one of the array of images of the keyboard, adding a first media content unit corresponding to the indicated one image to a message to be transmitted via the interpersonal messaging system and, in response to a user input instructing sending of the message, transmitting the message comprising the first media content unit to a computing device operated by a second user.

In another embodiment, there is provided at least one computer-readable storage medium having encoded thereon executable instructions that, when executed by at least one processor, cause the at least one processor to carry out a method of operating an interpersonal messaging system. The interpersonal messaging system enables a user to exchange messages with one or more other users in a communication session, in which at least some of the messages comprise text. The method comprises displaying, via a user interface, a keyboard of a set of media content units available for inclusion in messages transmitted via the interpersonal messaging system. Each media content unit comprises audio and/or visual content and is associated with at least one unit of metadata describing a content of the media content unit. One or more of the at least one unit of metadata for each media content unit describes the content identifies a concept expressed by the media content unit and/or an emotion to be triggered in a person viewing or listening to the media content unit. Displaying the keyboard comprises displaying an array of images, and each image of the array is associated with one of the set of media content unit. The method further comprises, in response to a single input of a user indicating one of the array of images of the keyboard, adding a first media content unit corresponding to the indicated one image to a message to be transmitted via the interpersonal messaging system and, in response to a user input instructing sending of the message, transmitting the message comprising the first media content unit to a computing device operated by a second user.

In a further embodiment, there is provided an apparatus comprising at least one processor and at least one computer-readable storage medium having encoded thereon executable instructions that, when executed by at least one processor, cause the at least one processor to carry out a method of operating an interpersonal messaging system. The interpersonal messaging system enables a user to exchange messages with one or more other users in a communication session, in which at least some of the messages comprise text. The method comprises displaying, via a user interface, a keyboard of a set of media content units available for inclusion in messages transmitted via the interpersonal messaging system. Each media content unit comprises audio and/or visual content and is associated with at least one unit of metadata describing a content of the media content unit. One or more of the at least one unit of metadata for each media content unit describes the content identifies a concept expressed by the media content unit and/or an emotion to be triggered in a person viewing or listening to the media content unit. Displaying the keyboard comprises displaying an array of images, and each image of the array is associated with one of the set of media content unit. The method further comprises, in response to a single input of a user indicating one of the array of images of the keyboard, adding a first media content unit corresponding to the indicated one image to a message to be transmitted via the interpersonal messaging system and, in response to a user input instructing sending of the message, transmitting the message comprising the first media content unit to a computing device operated by a second user.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A-1C illustrate flowcharts of exemplary processes that may have been implemented in conventional systems for exchanging messages between users;

FIG. 2A is an example of a manner in which users may operate computing devices to exchange interpersonal messages in accordance with some techniques described herein;

FIG. 2B is a flowchart of an exemplary process that may be implemented in some embodiments for exchanging content units between users of an interpersonal messaging system;

FIG. 3 is a flowchart of an exemplary process that may be implemented in some embodiments for exchanging content units between users of an interpersonal messaging system;

FIGS. 4A and 4B are examples of user interfaces that may be implemented in some embodiments;

FIG. 5 is a flowchart of an exemplary process that may be implemented in some embodiments for customizing sets of content units based on user input;

FIG. 6 is a flowchart of an exemplary process that may be implemented in some embodiments for creating a content unit;

FIGS. 7A and 7B are flowcharts of exemplary processes that may be implemented in some embodiments for suggesting content units to transmit in messages in place of other potential content of a message;

FIG. 8A is a flowchart of an exemplary process that may have been implemented in conventional systems for creating a message based on text input;

FIG. 8B is a flowchart of an exemplary process that may be implemented in some embodiments for creating an aggregate content unit based on multiple content units input by a user for inclusion in a message; and

FIG. 9 is a block diagram of some exemplary components of a computing device with which some embodiments may act.

### DETAILED DESCRIPTION

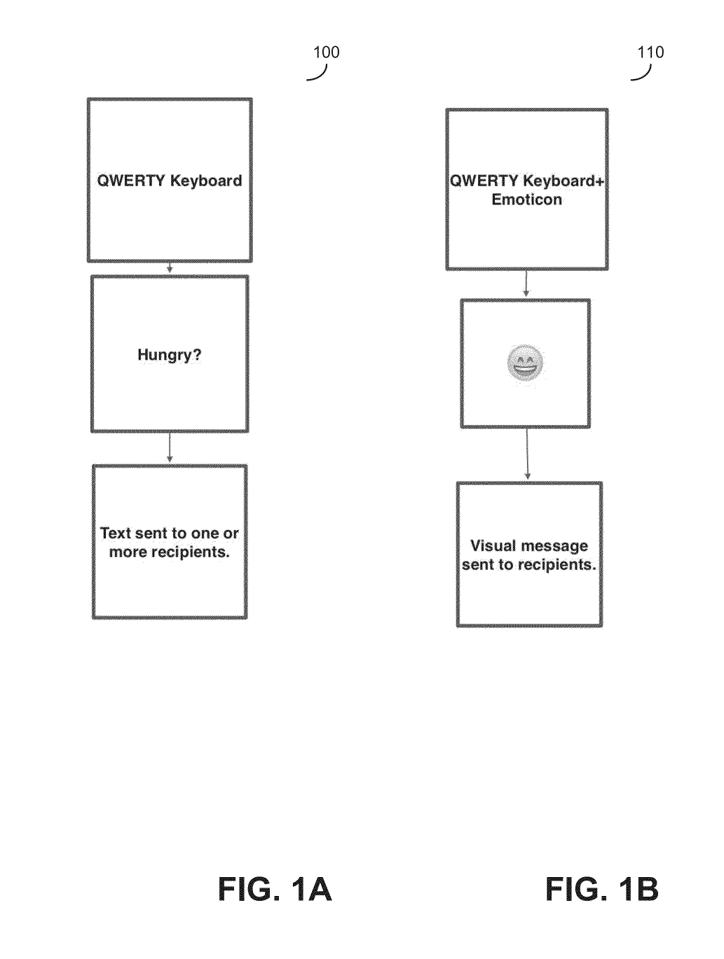

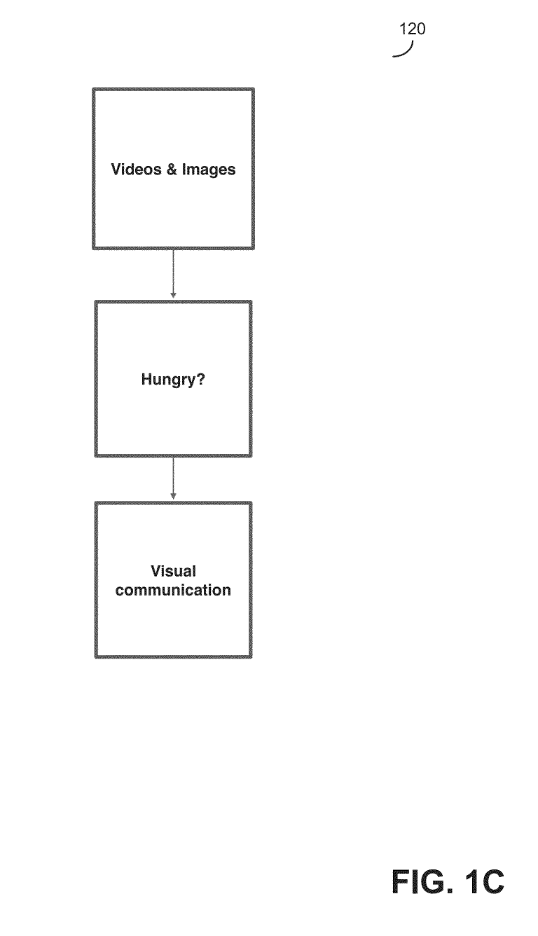

The inventors have recognized and appreciated that, in face-to-face oral communication, it is relatively easy to convey a meaning from one person to another, where the words used by a person are supplemented by variations in voice, facial expressions, hand gestures, body posture, and other forms of non-verbal communication that assist with expressing a meaning. The inventors have additionally recognized and appreciated, however, that with digital communication via computers, expressing meaning is more difficult. Digital communication, such as interpersonal communication like text messaging and instant messaging, has traditionally been carried out in a text format. For example, as illustrated in process 100 of FIG. 1A, a user may use a typical “QWERTY” keyboard to input a word or a string of words (“Hungry?”) and then request that the string words be sent to a recipient via the internet.

The inventors have recognized and appreciated that it can be difficult to express a concept using only text. This may especially be the case where a communication format encourages brevity, such as text messaging and instant messaging. A conventional solution to this problem includes particular combinations of punctuation characters, which are intended to assist in conveying one's meaning in short strings of text by combining the text with one such combination of punctuation characters. These combinations of punctuation characters, known as “emoticons,” can be used to suggest facial expressions that may have accompanied the text if the text had been spoken aloud. For example, one emoticon may indicate a smile (“:)”), which might suggest that the accompanying text should be read in a light-hearted or sarcastic way. In the case of some emoticons, images have been created as substitutes for the combination of punctuation characters. In the case of the smile emoticon, the combination of punctuation characters has been supplemented with a well-known “yellow smiley face” image that may be used instead of the punctuation characters. In some systems that make such emoticon images available to message senders, the images may accompany text in a similar way to how combinations of punctuation characters would have been sent. For example, as illustrated in process 100 of FIG. 1B, a user may use a “QWERTY” keyboard to input text and use an emoticon interface to select an image to send with the text, then request that the text and image be sent to one or more recipients. Messaging systems may also use video and sound to communicate (process 120, FIG. 1C).

The inventors have recognized and appreciated that while emoticons can assist with expressing meaning via text, it is still difficult to convey one's meaning effectively using only text and emoticons. Part of this problem arises because emoticons do not convey a singular meaning purely by themselves. With respect to the smile emoticon, for example, the emoticon may suggest a smile, but that smile could have any number of meanings: the person typing/sending the smile believes something is funny, or is happy, or is attracted to the message recipient, and so on. Emoticons, even when viewed in the context of the text that the emoticons accompany and/or in the context of previous text exchanged between a sender and the recipient, are only suggestive of myriad meanings that should be assigned to the text. Further, because the emoticons serve only to supplement the text, when the underlying meaning of the text is unclear, an emoticon may not provide any assistance to a sender in effectively convey his or her meaning.

The inventors have thus recognized and appreciated that digital communications can benefit from a mechanism for more effectively conveying a meaning between a message-sender and at least one message-recipient. Accordingly, described herein are various examples of systems and methods to aid effectively communicating a meaning.

In some embodiments, content units may be provided to a user of a system to assist that user in communicating a meaning. Each of the content units may be suggestive of a single concept and will be understood by a viewer to suggest that single concept. Any suitable concept may be conveyed by such a content unit, as embodiments are not limited in this respect. In some cases, some or all of the content units may be suggestive of an emotion and intended to trigger the emotion in a person viewing or listening to the content unit, such that a conversation partner receiving the content unit will feel the emotion when viewing or listening to the content unit or understand that the sender is feeling that emotion.

In the embodiments that include such content units, the content units are not limited to including any particular content to express concepts. The content units may include, for example, media content such as visual content and/or audible content, and may be referred to as “media content units.” Visual content may include, for example, images such as still images and video images. In some cases, visual content may include text in addition to images. Audible content may include any suitable sounds, including recorded speech of a human or computer voice (such as a voice speaking or singing), music, sound effects, or other sounds. The content may express the concept to be conveyed by showing the meaning through the audio and/or visual content. For example, in the case that a concept to be expressed is an emotion, the content may include an audiovisual clip showing one or more people engaging in behavior that expresses the emotion. Such behaviors may include speaking about the emotion or speaking in a way that demonstrates that the speaker or listener is feeling the emotion. In some cases, the content may be an audiovisual clip from professionally-created content, such as a clip from a studio-produced movie, television program, or song. In such a case, the clip may be of actors expressing the concept to be conveyed by the content unit, such as speaking in a way that expresses an emotion or speaking about the emotion, in the case that the concept is an emotion. In some cases, in addition to visual content, a media content may include text that is superimposed on at least a portion of the visual content, such as text superimposed on a still and/or video image. The text may additionally express a concept and/or emotion that is to be conveyed with the content unit.

It should be appreciated, however, that embodiments are not limited to using any particular content or type of content to express any particular concept or type of concept, as embodiments are not limited in this respect.

In embodiments that include such content units, the content units may be used in any suitable manner. In some embodiments, the content units may be used in an interpersonal messaging system (IMS), such as a system for person-to-person messaging and/or for person-to-group messaging. As a specific example of an embodiment in which such content units may be used in an interpersonal messaging system, the system may transmit one or more messages each comprising text, emoticons, and/or media content units from a first user of such a system (using a first computing device) to a second user (using a second computing device) to enable the first user to communicate with the second user via the system. The system may receive text input from the first user when the first user feels that text may adequately capture his/her meaning. The system may display such text messages, upon transmission/receipt, to both the first user and the second user (on their respective devices) in a continually-updated record or log of communication between the users. When the first user feels that text may be inadequate to convey a meaning or otherwise does not prefer to send a text message, the first user may provide input to the system by selecting one of the content units to send to the second user via the messaging system. The system may transmit the content unit upon detecting the selection by the first user. When content unit is received by the second user's device, the system may display the content unit to the second user automatically, without the second user expressly requesting that the content unit be displayed. For content units that include audio and/or video content, displaying the content unit automatically may include playing back the audio and/or video automatically. The system may also display the content unit to both the first user and the second user in the record of the communication between the users, alongside any text messages that were previously or are subsequently exchanged between the users and alongside any other content units previously or subsequently exchanged between the users.

While a specific example has been given of communicating content units via an interpersonal messaging system, it should be appreciated that embodiments are not limited to using content units in an interpersonal messaging context. In other embodiments, content units may be used in any context in which a person is to express a meaning via digital communication. For example, such content units may be used in presentations (e.g., by inserting such a content unit into a Microsoft® PowerPoint® presentation, such that the content unit can be displayed during the presentation) and in social networking (e.g., by including the content unit in a user's profile on the social network or distributing the content unit to other users of the social network via any suitable communication mechanism of the social network). Embodiments are not limited to using content units in any particular manner. It should also be appreciated that embodiments are not limited to implementing any particular user interface to enable users to select content units. In some embodiments, a system that provides content units to users may make the content units available for user selection via a virtual keyboard interface. A virtual keyboard may include an array of virtual keys displayed on a screen, which may be the same or different sizes, in which each key corresponds to a different content unit. The virtual keyboard may include thumbnail images for each key, where the thumbnail image is indicative of content of the content unit associated with that key. In some embodiments, physical keys of a physical keyboard may be mapped to the virtual keys of the virtual keyboard. In such embodiments, when the system detects that a user has pressed a physical key of the physical keyboard, the system may determine the virtual key mapped to the physical key and then select a content unit associated with that virtual key. In some embodiments, a user may additionally or alternatively select content units by selecting a virtual key of the virtual keyboard with a mouse pointer or by selecting the virtual key via a touch screen interface when the virtual keyboard is displayed on a touch screen display. Though, it should be appreciated that embodiments are not limited to using any particular form of user input in embodiments in which content units are available for selection via a virtual keyboard.

In some embodiments that use a virtual keyboard, a system may have a fixed number of keys in the virtual keyboard and may have more content units available for selection than there are keys in the keyboard. In this case, in some embodiments, the system may organize the content units into sets and a user may be able to switch the keyboard between different sets of content units, such that one set of content units is available at each time. When the user switches between sets, keys that were associated with content units of a first set may be reconfigured to be associated with content units of a second set. In embodiments that operate with such sets, the content units may be organized into sets according to any suitable categorization. In some embodiments, the categorization may be random, or the content units may be assigned to sets in an order in which the content units became available for selection by the user in the system. In other embodiments, the content units may be organized in sets according to the concepts (including emotions) the content units express. For example, content units that express negative emotions (e.g., sadness, anger, boredom) may be organized in the same set(s) while content units that express positive emotions (e.g., happiness, love, friendship) may be organized in the same set(s) that are different from the set(s) that contain the content units for negative emotions. In other embodiments, the content units may be organized according to the content of the content units. In some embodiments in which the content units are organized according to content, the type of content may be used to organize the content units. For example, content units that contain only still images may be in one or more sets, content units that contain only audio may be in another one or more sets, and content units that contain audiovisual video may be in another one or more sets. In other embodiments in which content units are organized according to content, content units may be organized according to a type of the content. For example, content units that are clips of professionally-produced video content may be organized into one or more sets and content units that do not include professionally-produced video content may be organized into one or more different sets. Content units that include professionally-produced video content may, in some embodiments, be further organized according to a source of the video content. For example, content units that include video content from a particular movie or television program, or from a particular television network or movie studio, may be organized into one set and content units that include content from a different movie/television program or different network/studio may be organized into another set.

In embodiments that use sets in this manner, the sets may be preconfigured and information regarding the set may be stored in one or more storage media, and/or the sets may be dynamically determined. For example, in some embodiments a user interface may provide a user an ability to set a filter to apply to a library of content units and display a set of content units that satisfy the criteria of the filter. In such a case, a set of content units that satisfy the filter may be retrieved from the storage media (in a case that the sets are preconfigured) or a query of content units may be performed to determine the content units. For example, as discussed in further detail below, in some embodiments metadata may be associated with each content unit describing a content of the content unit. The metadata may describe the content in any suitable manner, including by describing a type or source of the content, identifying the concept expressed by the content unit or an emotion to be triggered in a person viewing and/or listening to the content unit, describing objects or sounds depicted or otherwise included in the audio and/or visual content, and/or otherwise describing the content.

In some embodiments in which a system includes a virtual keyboard for selecting content units, the virtual keyboard may be paired with a virtual text-only, QWERTY keyboard. In these embodiments, the virtual keyboard may include an array of keys and the user can instruct the system to switch between associating textual characters (e.g., alphanumeric characters and punctuation marks) with the keys and associating content units with the keys. When textual characters are associated with the keys, the system may display, for each key, the textual character associated with the key, while when content units are associated with the keys, the system may display, for each key, a thumbnail for the content unit associated with the key as discussed above.

In some embodiments that include a virtual keyboard, the system may enable a user to configure and/or reconfigure the virtual keyboard. For example, a user may be able to change the location of content units in the keyboard by changing which content unit is associated with a particular key. As another example, in embodiments in which the content units are organized into different sets and a user can switch between the sets, a user may be able to change the set to which a content unit is assigned, including by rearranging content units between sets. Further, in some such embodiments in which a user can switch between sets of content units to display different content units in a virtual keyboard, the user may be able to switch between sets by scrolling through the sets in an order and a user may be able to change an order in which sets are displayed.

Embodiments that include content units, sets of content units, and keyboard may include any suitable data structures including any suitable data, as embodiments are not limited in this respect. In some embodiments, a content unit may be associated with one or more data structures that include the data for content of the content unit (e.g., audio or video data) and/or that include metadata describing the content unit. The metadata describing the content unit may include any suitable information about the content unit. The metadata may include metadata identifying the concept or emotion to be expressed by the content unit. For example, data structures for some content units may include metadata that is textual data expressly stating the concept (e.g., emotion) to be expressed by the content unit. As another example, the metadata may include textual data expressly stating a source of audio and/or visual content, such as a record label, television network, or movie studio that produced audio and/or visual content included in a content unit. As another example, the metadata may include textual data describing the audio and/or visual content, such as objects, persons, scenes, landmarks, landscapes, or other things to which images and/or sounds included in the content correspond.

A set of content units may be associated with one or more data structures that include data identifying the content units included in the set. In some cases, a data structure for a set of content units may also include information describing the content units of the set or a common element between the content units, such as a categorization used to organize the content units into the set. For example, if the categorization was a particular type of emotion, or a particular type of content, or a particular source of content, a data structure for a set may include metadata that is textual data stating the categorization. A virtual keyboard may also be associated with one or more data structures including data identifying which content units and/or textual characters are associated with buttons of the keyboard.

In some embodiments, a user may require authorization to use one or more content units, such as needing authorization to exchange content units via an interpersonal messaging system. This may be the case, for example, with content units that include copyrighted audio and/or visual content, such as video clips from television programs or movies or other professionally-produced content. In such systems, a user may need to pay a fee to obtain authorization to use such content units. The interpersonal messaging system may, in some embodiments, track for a particular copyright holder the number of users who obtain authorization to its works and/or a number of times its works are used (e.g., exchanged) in the system and pay royalties accordingly. In some embodiments, the system may make some content units and/or sets of content units available to a user when the user accesses the system for the first time and may make other content units and/or sets of content units available to the user for download/installation free or for a fee. In some such embodiments, the system may enable a user to search for content units or sets to download/install. The system may accept one or more words from a user as input and perform a search of a local and/or remote data store for content units or sets based on the word(s) input by the user. In some such embodiments, the system may perform the search based on metadata stored in data structures associated with content units and/or sets. For example, if a user inputs a word describing an emotion (e.g., “anger”), the system may search metadata associated with content units to identify one or more content units for which the metadata states that the emotion to be conveyed by the content unit is anger. In some embodiments, the system may also perform such a search, based on user input, of a local data store of content units to locate currently-available content units that express a meaning the user wishes to express.

In some embodiments, the system may suggest content units to a user to aid the user in expressing himself/herself. For example, in some embodiments the system may monitor text input provided by a user and determine whether the text input includes one or more words that indicate that a content unit may aid the user in expressing a concept. The system may do this, in some embodiments, by performing a search of metadata associated with content units that are available for selection by the user, such as content units for which the user has authorization to use. For example, the system may perform a local search (in a data store of a computing device operated by the user) of metadata associated with content units based on the word(s) input by the user. The text input provided by the user may not be an explicit search interface for the content units, but may instead be, for example, a text input interface for receiving user input of text to include in a textual message. In an embodiment in which content units are used with an interpersonal messaging system that also supports textual messages, the system may monitor text input by the user when the user is drafting a textual message to transmit via the system to determine whether to suggest a content unit that the user could additionally or alternatively transmit via the interpersonal messaging system to better express his/her meaning. As a specific example, a user may input, such as to a field of a user interface that includes content to be included in a message to be sent via an IMS, the text word “LOL” to indicate that the user is “laughing out loud.” In response, the system may perform a search based on the word “LOL” and/or related or synonymous words (e.g., the word “laugh”) to determine whether any content units (e.g., content units for which a user has authorization) are associated with metadata stating that the content unit describes laughing. If one or more content units are found, before the user sends the textual message “LOL,” the system may display a prompt to the user suggesting that the user could instead transmit a content unit to express his/her meaning. The prompt may include one or more suggested content units or the suggested content unit(s) may be displayed to the user if the user requests that the content unit(s) be displayed. The content units may be displayed in any suitable manner, including in a keyboard of images for the content units. If the user selects one of the suggested content units from the display, in response the system may substitute in the message the selected content unit for the text “LOL”, such that the system does not transmit the text in the message and instead transmits in the message the selected content unit.

In some embodiments, the system may also enable users to create their own content units for expressing concepts. In embodiments that permit users to create their own content units, the system may be adapted to perform conventional still image, audio, and/or video processing. For example, the system may enable users to input source content that is any one or more of still images, audio, and/or video and perform any suitable processing on that content. The system may be adapted to crop, based on user input, still images, audio, and/or video to select a part of a still image or a clip of audio/video. The system may also be adapted to, based on user input, insert text into a still image or a video. For example, when the user inputs text, the system may edit a still image to place the text over the content of the still image. After the system has processed the content, the system may store the content in one or more data structures. The system may also update one or more other data structures, such as by updating data structures related to a virtual keyboard to associate a newly-created content unit with a virtual key of the virtual keyboard. The system may, for example, edit the data structure to store information identifying a virtual key and identifying the newly-created content unit.

Various examples of functionality that may be included in embodiments have been described above. Specific implementations of this functionality are provided below as examples of ways in which embodiments may be implemented. It should be appreciated that embodiments are not limited to implementing any particular function or combination of functions described herein and are not limited to implementing all of the functions described herein. Further, described below are various embodiments of a system that may provide content units to users to assist the users in effectively conveying a meaning, and many of the specific examples given below are in the context of an interpersonal messaging system (IMS). Further, in some embodiments described below examples of an IMS are discussed in the context one such system, the TAPZ™ messaging system available from TAPZ™ Communications LLC of Needham, Mass. It should be appreciated from the foregoing discussion, however, that embodiments are not limited to operating with an interpersonal messaging system.

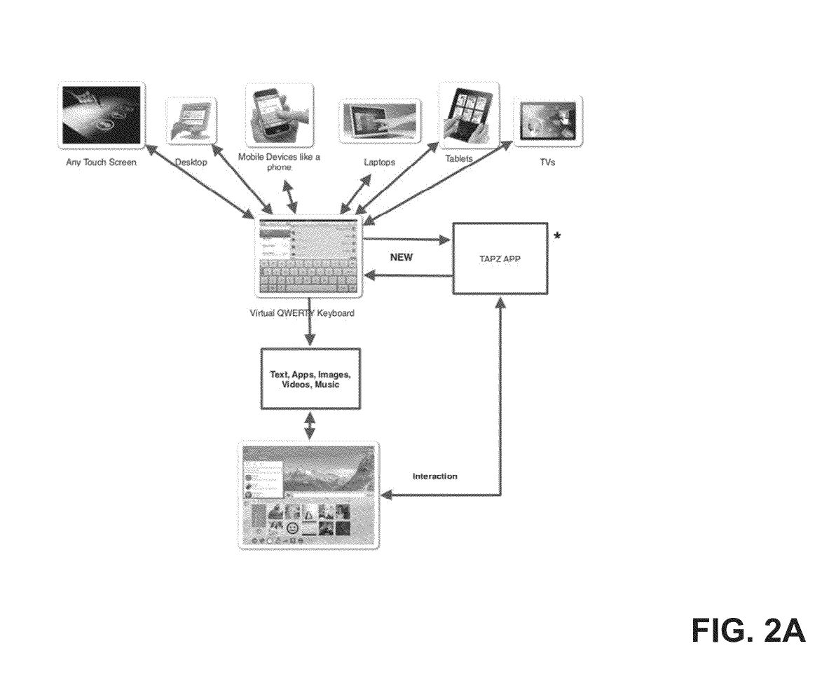

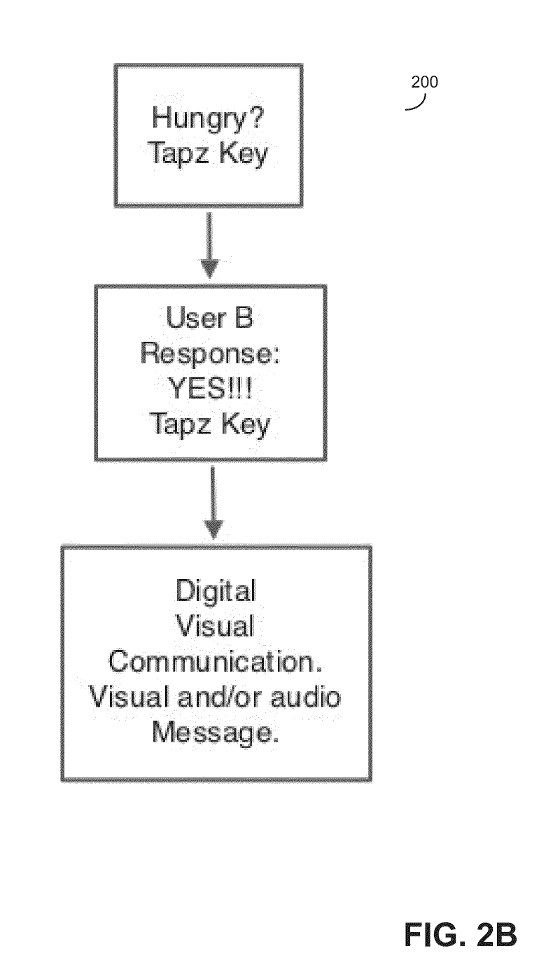

FIGS. 1A-C illustrate how devices that include QWERTY keyboards may have previously been used for communicating via text, emoticons or other visual images. FIGS. 2A and 2B show how such devices may interact with an IMS in accordance with embodiments described herein. FIG. 2B shows a process 200 by which an IMS (e.g., the TAPZ™ IMS) operating in accordance with techniques described herein can create a message conveying an inquiry from one user to another (Hungry?) using various forms of digital communications: one or combinations of digital visual and/or audio content units, text, and emoticons. While the conventional IMS of FIGS. 1A, 1B and 1C transmitted potentially ambiguous text and emoticons, respectively, the TAPZ™ IMS process 200 of the embodiment of FIG. 2B enables user to communicate via content units that each clearly express a concept (which may include an emotion or thought, or any other suitable concept). The content units of the example of process 200 may be, for example, audiovisual clips that illustrate a concept. For example, the system may detect a user selection, at a computing device, of a key of a virtual keyboard that is associated with a content unit that expresses the concept “hunger.” The concept “hunger” may be expressed in content in any suitable unambiguous manner. The content expressing hunger may be, for example, a short clip from the 1968 musical film “Oliver” in which the main character Oliver, when hungry, begs for more food from an orphanage worker. This video clip unambiguously demonstrates that the character in the clip is hungry and would be understood by a viewer to express the concept “hunger.” For example, when the IMS detects that the user has selected a virtual key associated with that content unit, the content unit is sent to a second user at a remote computing device via one or more datagrams of an interpersonal messaging protocol. The system may display the content unit to the second user, by which the second user may understand that the first user is hungry. The second user, upon viewing the content unit via the interpersonal messaging system, may then operate his/her computing device to select a key from a virtual keyboard. The system, upon detecting the key selection, may determine that the key is associated with a second content unit that expresses an emotion that is an excited “Yes!!!” The concept of an excited yes may be expressed in content in any suitable unambiguous manner. For example, the content expressing the excited affirmative may be an audiovisual clip of an actor repeatedly yelling “Yes!”, which a viewer would unambiguously understand means “yes.” The system, upon receiving the input from the second user, may transmit the “yes” content unit to the first user via one or more datagrams of the interpersonal messaging protocol. The system may then display the content unit to the first user at the first user's computing device and the first user may understand that the second user is agreeing that he/she is hungry. The interpersonal messaging system of this example thus permits the two users to unambiguously communicate with one another digitally using audiovisual content, rather than merely using text or emotions that may be ambiguous in a digital communication context. The interpersonal messaging system of this embodiment may therefore be used to enable digital visual communication through communicating visual and/or audio messages.

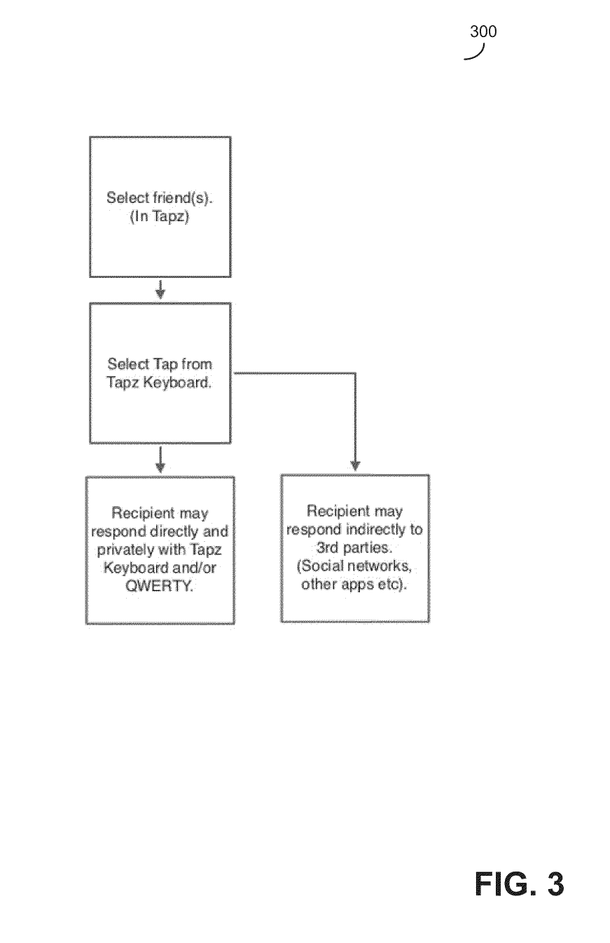

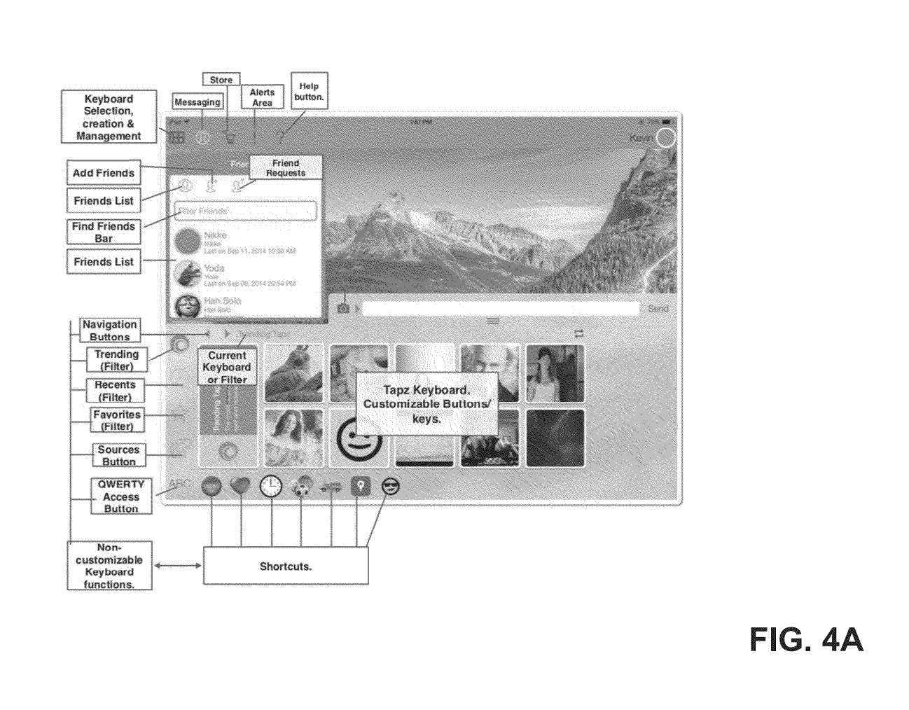

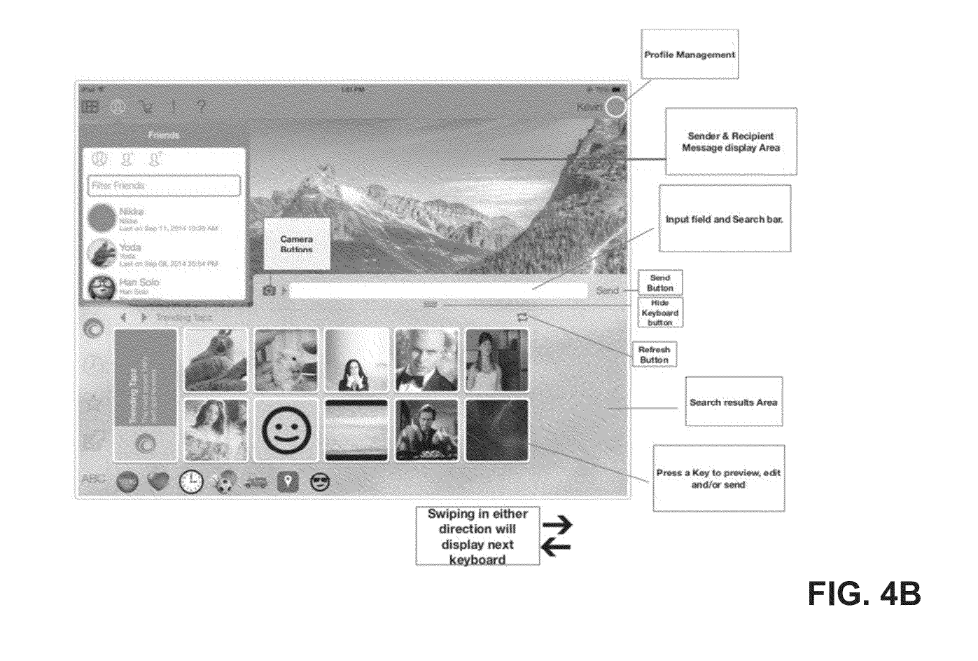

FIG. 3 is a flowchart of a process 300 that shows in more detail ways in which the IMS may be implemented in some embodiments. In the example of the process 300 of FIG. 3, the IMS may maintain a set of other users termed “Friends” (See exemplary interface in FIG. 4A and FIG. 4B) for each user. The friends may be other users that have previously received, from the user, a message via IMS or were previously added to the set by the user to indicate that he/she may message these other users in the future. These other users may not necessarily be personal friends of the user, but may be colleagues, acquaintances, or any other people. The “Friends” list may provide a mechanism for a user to select users to message via the system. In the example of FIG. 3, a first user who desires to communicate selects one or more other users from the “Friends” list. In response to detecting the user's selection, the IMS prepares to send messages to the selected user(s), which may include opening a communication channel between a computing device operated by the first user and devices operated by the selected user(s). As illustrated in FIG. 3, the system next detects a selection by the first user of a content unit from a virtual keyboard, which may be any suitable content unit expressing any suitable content. The system may then transmit the content unit to the selected user(s) via direct, private communication with the selected user(s), via relaying the message by one or more servers of the IMS, or via public communication via third-party services such as social networks or web applications.

In the case of direct, private communication with the selected user(s), the IMS may transmit one or more datagrams including the selected content unit to computing devices operated by the users, such as in the example of FIG. 2B. In that case, the recipient(s), if/when they respond to the first user's message, may respond directly to the first user with content units selected from a virtual keyboard and/or with text from a QWERTY keyboard. In the case that the first user sent the content unit to multiple recipients, responses from the recipients may be shared among all of the recipients in a “chat” format by the system transmitting datagrams including any user's response to computing devices operated by each of the other users. Alternatively, though, in some embodiments responses from each of the users may only be communicated to the first user, such as by the system only communicating a message from a second user to the first user by transmitting one or more datagrams to the computing device operated by the first user.

In the case of public communication via third-party services, the IMS may transmit the content unit to the server(s) hosting the third-party service via any suitable mechanism, such as via an Application Programming Interface (API) of the third-party service. The third-party service may then relay the content unit to the recipients in any suitable manner, including by making the content unit publicly available to all users of the service (including the recipients) via the service and transmitting a notification to the recipients that the content unit is available. If a third-party service is used, responses from the recipients may also be shared via the service, such as by being transmitted from computing devices operated by the recipients to the server(s) hosting the third-party service, stored by the service, and made publicly available via the service.

It should be appreciated that an interpersonal messaging system of this embodiment may be implemented in any suitable manner, as embodiments are not limited to using any particular technologies to create an interpersonal messaging system.

For example, embodiments that include interpersonal messaging systems are not limited to using any particular transmission protocol(s) for messaging. In some embodiments, an interpersonal messaging system may send messages between users using Short Message Service (SMS) or Multimedia Messaging Service (MMS) messages. In other embodiments, an interpersonal messaging system may use Extensible Messaging and Presence Protocol (XMPP) messages, Apple® iMessage® protocol messages, messages according to a propriety messaging protocol, or any other suitable transmission protocol.

Embodiments that include interpersonal messaging systems are also not limited to implementing any particular software or user interfaces on computing devices for users to access and use the interpersonal messaging system. FIGS. 4A and 4B illustrate examples of software that may be executed on computing devices to enable users to transmit messages via an interpersonal messaging system. It should be appreciated, however, that embodiments are not limited to implementing the user interfaces illustrated in FIGS. 4A and 4B.

FIGS. 4A and 4B illustrate a user interface that may be implemented in some embodiments. The user interface of FIGS. 4A and 4B may be displayed on a computing device of an individual user to permit the user to send and receive communications via the system. The user interface may be used on any suitable computing device, as embodiments are not limited in this respect. In some embodiments, the user interface may be implemented on a device that includes a touch screen, such as a laptop or desktop personal computer with a touch screen, a tablet computer with a touch screen, a smart phone with a touch screen, or a web-enabled television with a touch screen.

The exemplary user interface of FIGS. 4A and 4B includes, in the top-right of the interface, a sender/recipient message display area in which the interpersonal messaging system may display to the user a record of messages exchanged between the user and one or more other users of the system. The system may display in the message display area all text, emoticon, and content unit messages transmitted during a conversation between the user and the other user(s). The user interface may also include a list of “Friends” (FIG. 4A, top left) of the user to permit the user to initiate new conversations with users in the list or view current or prior conversations with those users. For example, when User A selects User B from the Friends list, if User A and User B previously communicated via the system, or previously communicated within a threshold period of time, the system may update the message display area of the interface to display the record of messages exchanged between the User A and User B from those previous communications. If, on the other hand, User A and User B have not previously communicated with the system, or had not previously communicated within a threshold period of time when User A selects User B from the Friends list, the system may begin a new conversation and prompt User A to input a message (e.g., a text message or a content unit) to send to User B in the new conversation. If the user subsequently selects another user in the list of Friends (e.g., User C), the system may similarly respond by displaying a record of an in-progress conversation between the User A and User C or by initiating a new conversation.

In the user interface of FIG. 4A, when a message is received from another user and includes a media content, at a time that the message is displayed in the message display area of the user interface, the media content may also be played back via the interface automatically, without input from a user. For example, the IMS may automatically reproduce the audio or video content for the user in the interface in response to receiving the message. During playback, the interface may enlarge display of the content unit in some embodiments, such as by displaying the content unit in a window within the user interface that is as large or larger than the message display area. Following playback of the media content, the IMS may display in the message display area, in the record of messages for the conversation, a thumbnail image for the media content. Subsequently, if the user of the user interface selects (e.g., clicks on) the thumbnail image for the media content in the record of the conversation, the interface may play back the media content again in the same manner.

The user interface of FIG. 4A includes, in the top left of the interface, a listing of “Friends” that may be contacted via the interpersonal messaging system, in addition to functionality related to a Friends listing such as a “Friends List” function to view the listing, an “Add Friends” function to add users to the list by asking the system to send an invitation to another user to authorize the addition of that user to the Friend List, a “Friend Request” function to view received requests from other users for authorization to be added to their friend lists, and a “Filter Friends” function that can receive text input of a filter criteria and filter the Friend List for users whose names or other profile information include text satisfying the filter.

The user interface of FIGS. 4A and 4B also includes an example of a virtual keyboard that may be displayed to the user in some embodiments to enable the user to select a content unit to transmit to a recipient via the interpersonal messaging system. The virtual keyboard includes an array of virtual keys that are each an image, such that the virtual keyboard is an array of images. Each virtual key is associated with a particular content unit that the user may select and transmit to a recipient via the system. As shown, each of the virtual keys is displayed with a thumbnail image that depicts or suggests at least some of the content of the content unit associated with that key.

In the exemplary user interface of FIGS. 4A and 4B, to select a content unit to send to a recipient, the user may tap (i.e., using the touch screen, press and release quickly) the virtual key associated with the desired content unit. In response to the user tapping the virtual key, the system may determine the content unit associated with the key and determine recipients of the content unit by determining the other user(s) with which the user is communicating in the conversation currently displayed in the send/recipient message display area. The system may then transmit the content unit to the recipient(s).

In some embodiments, the system may respond to the single tap of the virtual key by the user by sending the content unit, without prompting the user to take any other action. In other embodiments, however, the system may additionally prompt the user to confirm the selection and/or specifically instruct transmission, as embodiments are not limited in this respect. In embodiments in which the system may prompt the user to specifically instruct transmission, the system may add a selected content unit to a message to be transmitted in response to a single input of the user, such as a single tap of the virtual key corresponding to the content unit. The system may add the content unit to a message in any suitable manner. For example, in a case that other content had previously been added by a user to a to-be-transmitted message, in response to the single input from the user the system may add the content unit to the set of other content to be included in the message. For example, a user may have previously input text, emoticons, or other content units for inclusion in the message. In response to the single input of the user (e.g., the tap of the virtual key), the system may add the content unit to the other content of the to-be-transmitted message, such as by storing data indicating that the content unit is to be transmitted or adding the content unit to a data structure corresponding to the to-be-transmitted message. Following the addition of the content unit in response to the single input, other content may also be added to the message, such as text or other content units.

The user interface of FIG. 4A illustrates a user input field, between the message display area and the virtual keyboard, for receiving content to be included in a message, including text, emoticons, or content units. In response to the single input of the user, the user interface may additionally add the selected content unit to this user input field to indicate to the user that the content unit has been added to the message. The content unit may be displayed in the user input field, such as by displaying a thumbnail image for the content unit, alongside other content to be included in the message, such as text content added to the message before or after selection of the content unit.

The virtual keyboard may also enable a user to preview a content unit associated with a virtual key by pressing and holding the virtual key via the touch screen (as opposed to tapping the virtual key). When the system detects that the user has pressed and held a virtual key, the system may respond by determining the content unit associated with that virtual key and then displaying that content unit to the user in the user interface. The system may display content units in any suitable manner. For content units that are still images, the system may show the still image to the user in the interface. For content units that are audio and/or video, the system may reproduce the audio/video, such as by playing back the audio and/or video in the user interface and/or via an audio output (e.g., speakers) of the computing device.

The virtual keyboard of FIGS. 4A and 4B may permit a user to input text as well as select content units. In addition to switching between sets of content units, the user may switch the virtual keyboard to displaying text characters. For example, by swiping the virtual keyboard, the user may be able to switch between sets of content units and switch between displaying content units and displaying text characters. When the virtual keyboard displays text characters, each of the virtual keys of the virtual keyboard may be associated with a particular text character. When text characters are displayed and the user taps a virtual key, the text character associated with that virtual key will be inserted into a textual message to be transmitted by the system to a recipient. The textual message, prior to transmission, may be displayed to a user in a text input box not illustrated in FIGS. 4A and 4B. Thus, using the keys of the virtual keyboard, a user may input textual characters for transmission to one or more recipients or select content units for transmission to one or more recipients.

In the example of FIGS. 4A and 4B, content units are organized into multiple sets and the user interface enables a user to switch between displaying each of the multiple sets in the virtual keyboard. In this example, when the user uses the touch screen to swipe across the virtual keyboard, the system will switch the virtual keyboard from displaying one set of content units to displaying another set of content units, and thereby make the other set of content units available for selection by the user.

It should be appreciated that embodiments are not limited to organizing content units into sets according to any particular categorization schema. Content units may be organized into sets according to concepts or emotions expressed by the content units, according to objects or sounds included in the audio and/or visual content of the content units, according to a source of professionally-produced audio or video (e.g., a television network, movie studio, or record label that produced the audio or video content), or by explicit user categorization, or any of various other schemas by which content units could be organized into sets.

The user interface illustrated in FIG. 4A also includes “Filter” buttons to filter a library of content units to display in the virtual keyboard a set of content units satisfying the criteria of the filter. Any suitable criteria may be used to filter a library of media content and may be associated with a filter button, as embodiments are not limited in this respect. “Trending”, “Favorites”, “Recents”, “Opposite”, and “Amp” are just a few examples of Filters that may be used in some embodiments.

A “Trending” filter may be associated with a set of content units that the interpersonal messaging system has identified as most often exchanged between users over a recent period of time, such as within a past threshold amount of time. In embodiments that support a “Trending” filter, one or more servers of the interpersonal messaging system may identifier content units exchanged between users and track a number of times each content unit has been exchanged. From that information, the server(s) may determine a number of content units (e.g., a number corresponding to the number of virtual keys in a virtual keyboard of the interface) that were exchanged most often over the time period.

A “Favorites” filter may be associated with content units that a particular user has flagged as his/her favorite content units. In embodiments that support a “Favorites” filter, profile information for a user may be stored locally on a device and/or on one or more servers of the interpersonal messaging system and such profile information may include a set of one or more content units that a user has identified, via the user interface, as preferred by the user.

A “Recents” filter may be associated with content units that a user has transmitted to another user recently. In embodiments that support a “Recents” filter, the interpersonal messaging system may track content units transmitted by a user and, from that information, identify a set of recently-transmitted content units. The set of recently-transmitted content units may be content units transmitted within a threshold period of time, in some embodiments. In some embodiments, the set of content units may include a maximum number of content units (e.g., a number corresponding to the number of virtual keys in a virtual keyboard of the interface) and the system may maintain an ordered list of content units in the set. When a content unit is transmitted by the user via the system, the IMS may add that content unit to the set and to the top of the list. If a recently-used content unit was already in the set when used, the system may keep the content unit in the set and move the content unit to the top of the list. If a content unit is to be added to the set and to the top of the list and adding the content unit would mean that the maximum number of content units would be exceeded, the system may remove the content unit at the bottom of the list from the set to prevent the maximum number from being exceeded. In embodiments that maintain such a list of recently-used content units, when the user selects the “Recents” button in the interface, the system may switch the virtual keyboard to displaying the content units of the recently-used set in the virtual keyboard.

Content units may be organized into sets based on the concepts to be expressed by the content units, such as laughter content units, love content units or by other concepts or emotions. Concepts or emotions may have relationships and, accordingly, sets based on concepts or emotions may have relationships as well. Filters may then be based, in some embodiments, on such relationships between concepts/emotions. For example, an interpersonal messaging system may display some Filter buttons in response to determining that a currently-displayed set of content units in the virtual keyboard all express the same or similar concept, or are intended to trigger the same or similar emotion.

An example of such a Filter button is an “Opposite” button. The “Opposite” button enables a user to request display of content units of a set that conveys a meaning that is the opposite of the concept expressed by the currently-displayed set of the virtual keyboard. For example, if a “love” set is currently displayed in the virtual keyboard, in response to a user selecting the “Opposite” button the system may determine that an opposite meaning of “love” is “hate” and then filter a library of content units to display in the virtual keyboard a set of content units that each express the emotion “hate.” The system may determine an opposite concept/emotion, or a set of content units having the opposite meaning, in any suitable manner. In some cases, the system may be preconfigured with information regarding concepts/emotions that are opposites of one another, such as by a user or administrator of the system flagging two sets as having opposite meanings. The system may then use the preconfigured information to determine the opposite set.

A similar example of a Filter button based on relationships between concepts is an “Amp” button. An “Amp” button may be associated with a filter that identifies an intensified version of an emotion or concept of a currently-displayed set of content units. For example, if the system determines that the concept “yes” is expressed by each of the content units of the displayed set, the system may identify an extreme “YES!” as an “Amp” version of the concept “yes” and identify content units that express “YES!” As another example, if the system determines that the emotion “like” is expressed by each of the content units of the displayed set, the system may identify “love” as an “Amp” version of the concept “like” and identify content units that express “love.” The system may determine the set having the opposite meaning in any suitable manner. In some cases, the system may be preconfigured with information regarding sets that are opposites of one another, such as by a user or administrator of the system flagging two sets as having opposite meanings. The system may then use the preconfigured information to determine the opposite set. The system may determine an intensified concept/emotion, or a set of content units having the intensified meaning, in any suitable manner. In some cases, the system may be preconfigured with information regarding concepts/emotions that are related with one being an intense version of another, such as by a user or administrator of the system flagging two sets as having the related meanings. The system may then use the preconfigured information to determine the intensified set.

In embodiments that include Filters based on relationships between concepts, content units of sets may be identified locally, on a device operated by a user, or on one or more servers, as embodiments are not limited in this respect. In addition, in embodiments in which sets of content units are not preconfigured, content units to include in a set may be identified in any suitable manner. For example, in some embodiments each content unit may be associated with metadata identifying the concept or emotion expressed by the content unit and the interpersonal messaging system may identify content units to include in a set that express a concept or emotion through searching this metadata.

In addition to or as an alternative to the Filter buttons, the user interface of FIGS. 4A and 4B may additional provide a search interface to a user to enable a user to search for content units that express a particular concept or emotion. The “Search” interface may allow a user to provide a text input to the system. In response to receiving the text input from the user, the system may perform a search of the content units locally stored in the content unit library and/or a remote search of content units that are available for download by the user. The search may be carried out in any suitable manner, as embodiments are not limited in this respect. In some embodiments, each content unit is associated with at least one data structure that includes metadata describing a concept that is expressed by the content unit. The system may perform a search based on the user's text input by searching for content units for which at least a part of the metadata matches the user's text input. The system may also search based on words or phrases that are known to be synonymous with or related to the words/phrases input by the user, to increase the likelihood of identifying a content unit that may assist the user. The system may determine synonymous or related terms in any suitable manner, as embodiments are not limited in this respect. For example, the IMS may be configured by a user and/or administrator with a listing of related words/phrases. As another example, the system may query a local or remote thesaurus service to determine synonymous or related words. As a specific example of this functionality, if the user inputs “LOL” to the system for inclusion in a textual message, the system may search the metadata for “LOL” but may also search the metadata for “laughter” because laughter is related to “LOL.”

In some embodiments that support such a search functionality, the text input for the search may be input to the same user input field of the interface to which a user may input text for inclusion in a message. In such embodiments, in response to user input of text, such as in response to input of each letter or other character, the system may search for content units corresponding to the text. If content units are located in response to the search that correspond to the text, the interpersonal messaging system may present the content units to the user in the form of a suggestion to the user that one of the content units could be inserted in the message in place of the text. For example, if a user is searching for content units that express the concept hunger and provides the word “hunger” as the text input, the system will search for content units whose metadata includes the word “hunger.” As the content units whose metadata includes the word “hunger” are those that express the concept hunger, these content units may be those sought by the user and that may assist the user in expressing a meaning. The system may display the content unit(s) identified in the search as search results to the user, such as by displaying them in the virtual keyboard, with each result associated with a specific key. The user may then select one of the results to include that result in a message transmitted via the system. If the user selects one of the content units, the system may respond by substituting the content unit for the text in the to-be-transmitted message, such as by removing the text and adding the selected content unit.

The interface of FIGS. 4A and 4B may also include “Shortcut” buttons. As discussed above, in some embodiments content units may be organized into multiple sets. The sets may be organized according to any suitable scheme, as embodiments are not limited in this respect. In some cases, content units that express the same or similar concepts may be organized into a set. For example, content units that all express laughter may be organized into one set and content units that all express love may be organized into another set. In the example of FIGS. 4A and 4B, the interface includes buttons that request that specific sets of content units be displayed in the virtual keyboard. For example, if the user selects the “Yes/No” button in the interface, the system may switch the virtual keyboard to display the content units that are organized into the yes/no set, or into either a “yes” set or a “no” set. Similarly, if the user selects the “Love” button in the interface, the system may switch the virtual keyboard to display the content units that are organized into the love set. Similarly, when the user selects the “Sports” button, the system may switch the virtual keyboard to display content units that include audio and/or visual content, or express concepts or emotions, that relate to sports.

The user interface of FIGS. 4A and 4B includes other buttons to access other functionality of the interpersonal messaging system. A “Store” button provides access to an interface by which a user can search for content units or sets of content units to be purchased, downloaded, and/or installed on the user's computing device to make the content units available for being displayed in the virtual keyboard and selected by a user for transmission to a recipient. In systems in which a user must obtain authorization to transmit some content units, the user may be able to obtain the authorization via the store. A “Help” button provides information to users to assist them with using the interface, such as by displaying a TAPZ™ keyboard of “Frequently Asked Questions” (FAQ) FIG. 4A. The interface also includes other buttons that perform system navigation and other functions. For example, the other buttons may include an ABC key to open a virtual “Qwerty” keyboard for inputting textual character, numbers and punctuation marks. When the ABC button is selected, the system may respond by adjusting a display of the virtual keyboard to display text characters available for inclusion in a message. For example, the system may adjust display of the virtual keyboard such that the array of virtual keys (e.g., images) is swapped with an array of text characters, and each image in the array of images is replaced by a text character. In some embodiments, the keys of the Qwerty keyboard may align precisely with the keys of the virtual keyboard for content units, such that the keys are in the same positions and arrangements and only the content of each individual key is changed. A “Camera” button enables a user to operate a camera included in the user's computing device (e.g., a camera integrated in a tablet computer) to capture a photograph and transmit the photograph in a message via the system. When the user selects the “Microphone” button, the system may activate a microphone of the user's computing device and capture audio content input by the user, such as speech from the user. The audio content captured via the microphone may then be transmitted via the system as a content unit.

In some embodiments, sets of content units displayed in the virtual keyboard may be arranged into an ordered group of sets. The sets may be ordered in any suitable manner, as embodiments are not limited in this respect. In such embodiments, by providing a user input, such as “swiping” across the virtual keyboard on a touchscreen, the user may request that a next set (either a preceding or succeeding set, depending on the input) be displayed in the virtual keyboard. The system may respond to the input by identifying content units of the next set and displaying thumbnails for the content units in the virtual keyboard.

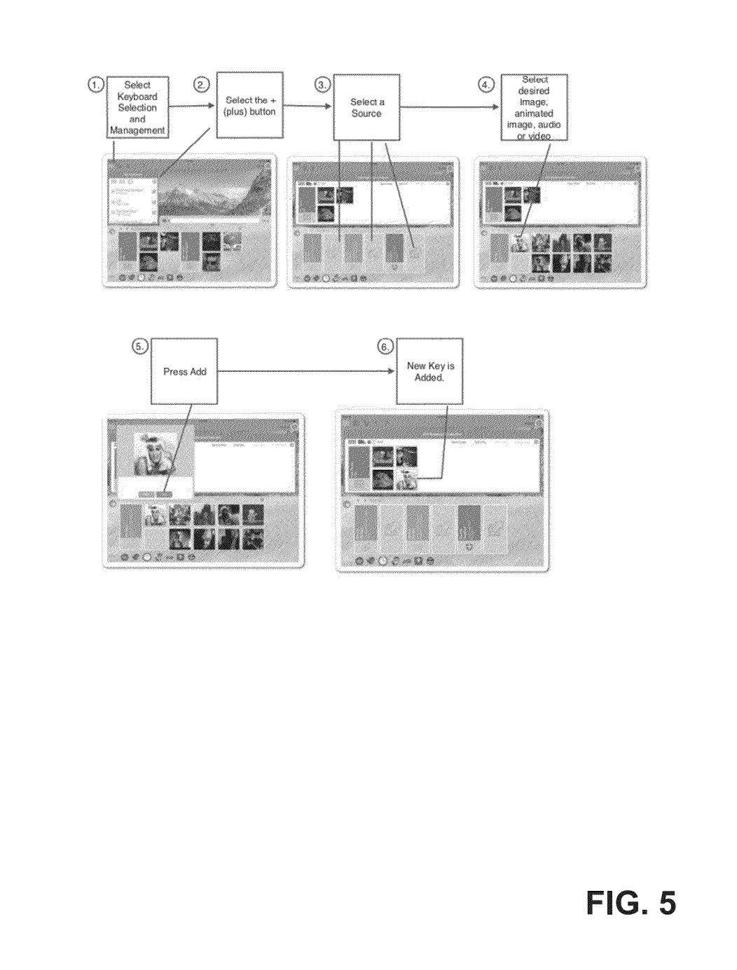

The virtual keys of the virtual keyboard of FIGS. 4A and 4B may be customized by the user in some embodiments. Customizing keys may include rearranging content units in the virtual keyboard, adding content units to the virtual keyboard, and/or removing content units from the virtual keyboard. For example, a user may be able to use the touch screen interface to move a content unit from being associated with one virtual key of the virtual keyboard to another key of the virtual keyboard. To do so, a “Keyboard Creator” interface may be displayed to a user, an example of which is shown in FIG. 5.

In the example of FIG. 5, the system displays a set of content units and the arrangement in which they will be shown to the user in the virtual keyboard, when that set is displayed in the virtual keyboard. The arrangement is based on data stored by the system in one or more data structures related to the set of content units and/or to the virtual keyboard. The data structure(s) store data identifying each content unit of a set and identifying a virtual key that is to be used to display the content unit and by which the content unit will be available for selection.

To copy or move a content unit from one keyboard to another keyboard, the Keyboard Creator must be selected. The user may use the touch screen interface to press the +(plus) button to create a new keyboard or edit an existing keyboard by selecting a keyboard in the list. Next, select the source of the content unit. Once the source of the content unit has been chosen, select the desired content unit to add by pressing it (on the touch screen interface) in the keyboard in the bottom half of the display and press Add. The user can then use the touchscreen interface to reposition the content unit within this new keyboard if so desired. In response to this addition, the system edits the data structure(s) to reflect that the content unit is to be associated with the new virtual key. To remove a content unit from the set and thereby prevent the content unit from being displayed in the virtual keyboard when the set is displayed, the user may use the touch screen interface to tap (i.e., quickly press and release) a virtual key to select the content unit, then click edit and then delete button in the interface. In response to the selection of the content unit and the delete button, the system edits the data structure(s) to remove an association between a content unit and a virtual key.

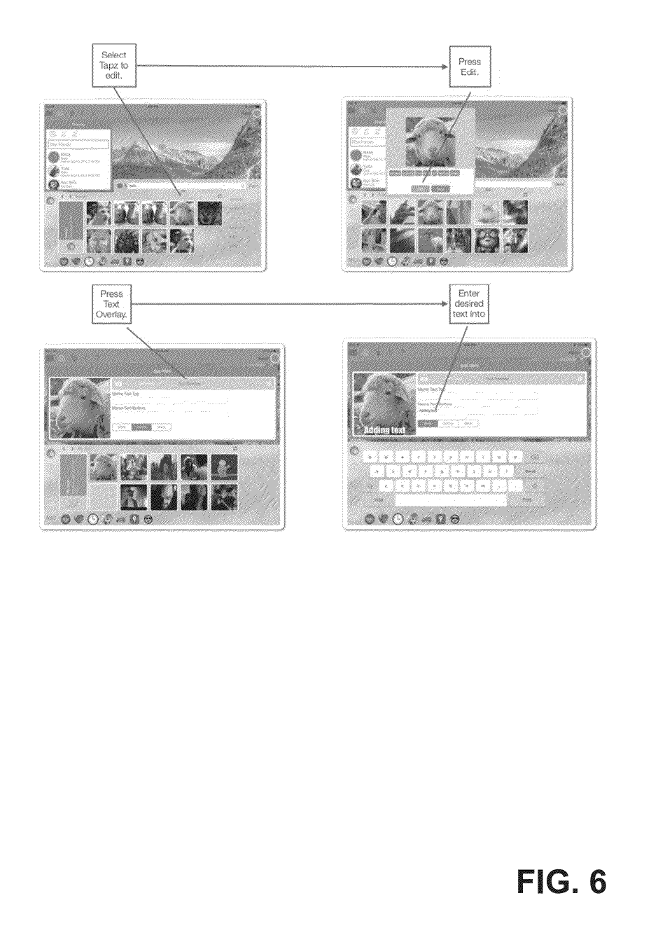

Some embodiments may permit a user to create content units for transmission to other users via the system. FIG. 6 illustrates examples of processes that may be used to create new content units and add the content units to a set of content units and to the virtual keyboard. It should be appreciated, however, that embodiments are not limited to implementing functionality to enable users to create content units, nor are embodiments that implement such functionality limited to implementing the processes of FIG. 6.

The process of FIG. 6 begins with a user requesting to create a new content unit by selecting an audio and/or visual content, such as an existing content unit, and clicking an “edit” button in the user interface. The user may then be presented with an option to input text to be superimposed over at least a portion of the content, such as text to be imposed over some or all frames of a video image or over a part of a still image. Once the text is input, a new audio and/or visual content may be created that includes the original audio/visual content and the superimposed text, such as by creating a new image file. A user may then be prompted to enter metadata for the content, such as by entering text describing content of the audio/visual content and/or identifying a concept or emotion expressed by the content. The metadata may then be associated with the audio/visual content and a content unit created, such as a file that includes both the audio/visual content and the metadata. Once the content unit is created, the content unit may be added to a set of content units and thereby made available for display in the virtual keyboard. The new content unit may be, by default, added by the system to a virtual key that would not have been used to display a content unit when the set was displayed, and is therefore “open” to be associated with the new content unit. After the content unit is associated with the virtual key, the system may display the set of content units in a “Keyboard Creator” interface, such as the one discussed above in connection with FIG. 5. Once the content unit is displayed in the keyboard builder interface, the user may move the content unit to a desired virtual key, such as using the process for moving content units between keys described above in connection with FIG. 5.

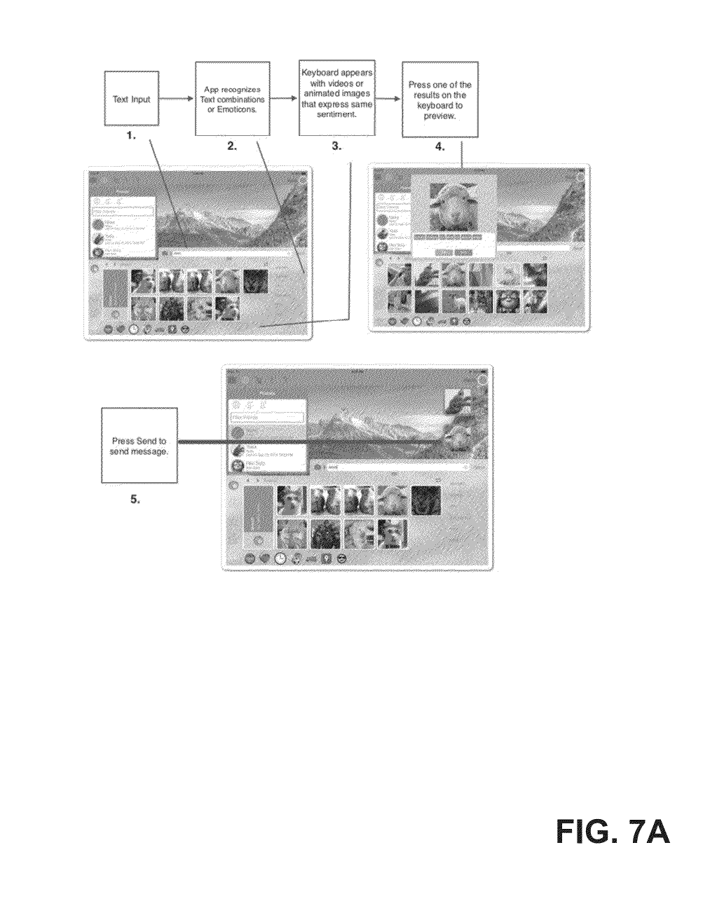

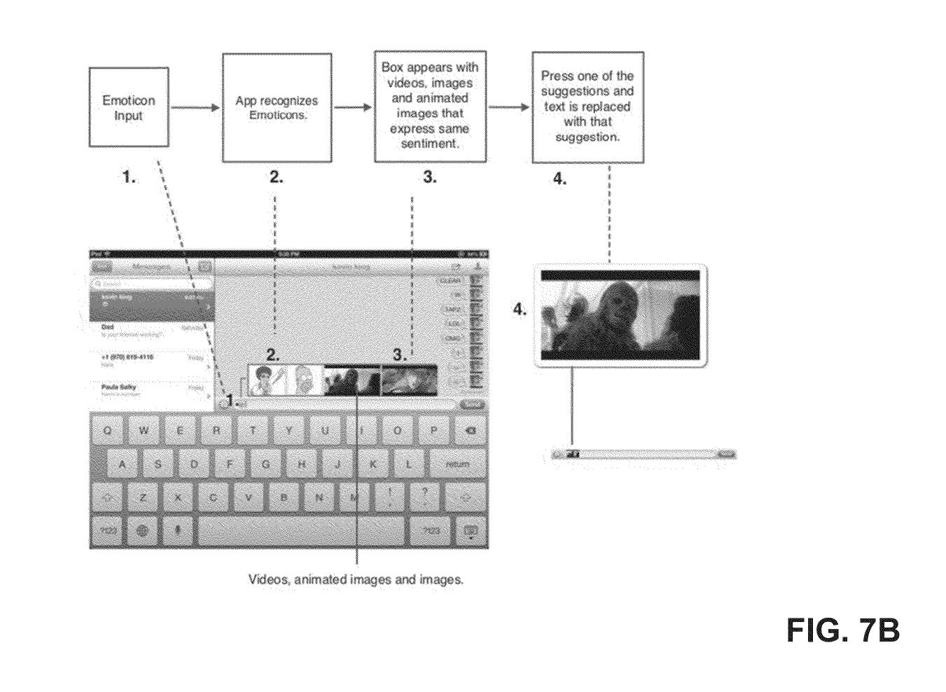

As discussed above in connection with FIG. 5, in some embodiments the IMS may permit a user to search for content units that express a meaning that the user would like to express by providing explicit input via a search interface. In some embodiments, in addition to or as an alternative to permitting searching via a search interface, the system may perform searching in response to a user inputting text and/or emoticons into a user input box of the user interface as part of writing a textual message. Thus, when a user originally intends to send a textual message, but the system determines that a content unit may assist the user with more effectively conveying his/her meaning, the system may suggest one or more content units that the user can use instead of text. FIGS. 7A and 7B illustrate examples of processes that may be used in some embodiments to suggest content units to a user.

The Autosuggest process of FIG. 7A begins with a user providing text input to the system that the user intends to transmit via the system in a textual message to one or more recipients. As discussed above, text may be ambiguous and a user's meaning may not be effectively conveyed in text. Accordingly, when the user inputs one or more words or phrases in text, the system may search a library of content units based on at least some of the input words or phrases. As discussed above in connection with FIGS. 4A and 4B, the system may perform searches of metadata associated with each of the content units based on text input by a user to a search box. A similar process may be carried out in the context of determining content units to suggest to a user. When a user inputs the words/phrases, the system may perform a search of the metadata of content units in the library based on some or all of the words or combinations of words that appear in the text input by the user. In some cases, the system may also search on words or phrases that are known to be synonymous with or related to the words/phrases input by the user, to increase the likelihood of identifying a content unit that may assist the user. For example, if the user inputs “LOL” to the system for inclusion in a textual message, the system may search the metadata for “LOL” but may also search the metadata for “laughter” because laughter is related to “LOL.” If, through the searching, the system identifies one or more content units that have metadata that matches the input words/phrases, the system may then display a thumbnail for those content units adjacent to the text input by the user. The thumbnails that are displayed by the system may function similar to the virtual keys of the virtual keyboard: a user taps one of the thumbnails to insert the content unit into the message or may press and hold one of the thumbnails to preview the content unit associated with that thumbnail. If the user taps one of the thumbnails to select the content unit for inclusion in the message, the system may either replace the text or supplement the text with the content unit, as embodiments are not limited in this respect. In a case in which the system replaces the text with the content unit, the system removes some or all of the text that the user had input from the message that the user is preparing for transmission and inserts the content unit in place of the removed text. The system may then, in response to an instruction from the user, send the content unit to a recipient.

As illustrated in FIG. 7B, the system may additionally or alternatively perform a suggestion process in response to a user inputting an emoticon for inclusion in a message to be sent via the system. As discussed above, emoticons have ambiguous meanings and may not clearly express a meaning that a user would like to convey. Accordingly, when a user inputs an emoticon, the system may search for a content unit to suggest that the user use in place of the emoticon. The process of FIG. 7B is an example of such a process for suggesting a content unit to replace an emoticon in a message. The process of FIG. 7B includes steps similar to steps included in the process of FIG. 7A. These similar steps will not be discussed further. The primary distinction between the processes of FIGS. 7A and 7B relates to the words/phrases that form the basis of the search. In the example of FIG. 7A, the words/phrases of the search are words/phrases input by the user. In the case of FIG. 7B, however, when the user inputs an emoticon, the system selects the words/phrases to be searched. Because emoticons do not have a single clear meaning, the system may be preconfigured with a meaning to assign to emoticons. For example, the system may be preconfigured with information assigning the meaning “happy” to a smiley emoticon, assigning the meaning “laughter” to a tongue-stuck-out emoticon, and assigning other meanings to other emoticons. When the user inputs an emoticon, the system may retrieve the meaning assigned to the emoticon. The system may then perform a search based on that meaning, such as using the process discussed above in connection with FIG. 7A. If a user selects a content unit after the content units are displayed to the user in the interface, the system may then, in response to an instruction from the user, send the content unit to a recipient. When the system sends the content unit to the recipient, the system may send the content unit in addition to the emoticon, or may remove the emoticon from the message before sending the message and send the content unit instead of the emoticon.

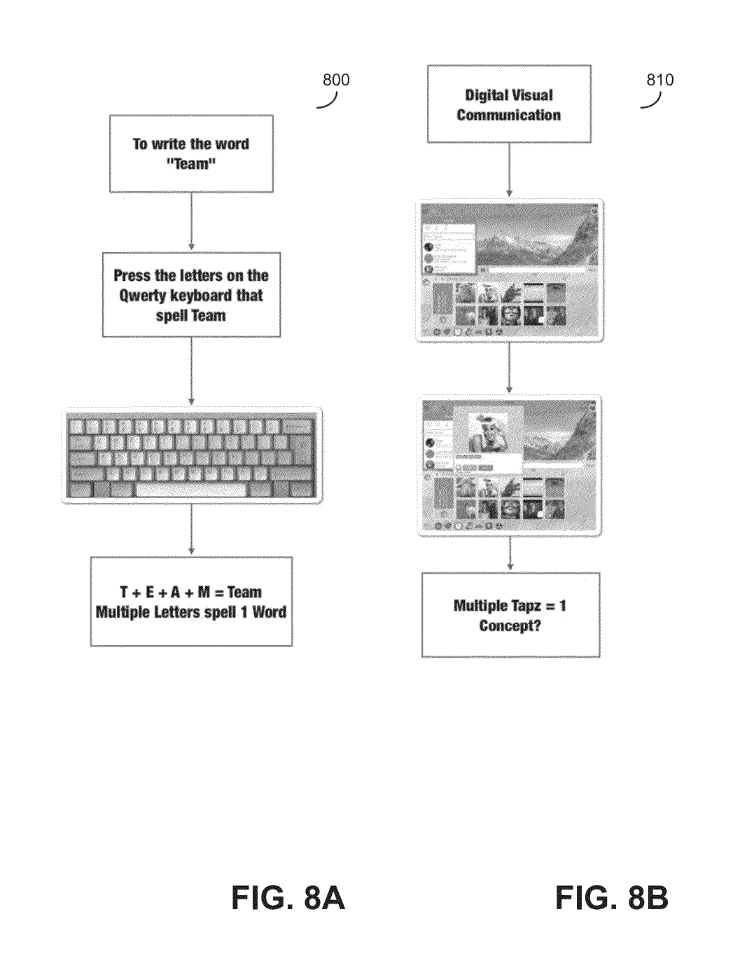

As should be appreciated from the foregoing, in some embodiments a user may be able to add multiple content units to a single message, to be transmitted together to another user (or users) via the interpersonal messaging system. In conventional text-based systems, as in the example of the process 800 of FIG. 8A, text input is combined to form a whole that is greater than the sum of its parts—a combination of letters results in a word that expresses a meaning greater than the meaning of any of the constituent letters. In some embodiments, an interpersonal messaging system may similarly combine content units together to generate an aggregate content unit that may, in some cases, express a meaning that is greater than the sum of its parts or a meaning that is more than the combined meanings of the constituent content units.

FIG. 8B illustrates an example of a process 810 that may be implemented in some embodiments for creating an aggregate content unit from multiple input content units. In the case that the process 810 of FIG. 8B is to be implemented, the system may receive as input multiple content units to be included in a message to be transmitted via the interpersonal messaging system. The multiple content units may be received in any suitable manner, including any of the exemplary ways of receiving or inputting contents units described above, as embodiments are not limited in this respect. In response to a user instruction to send the message including the multiple content units, the content units may be received by a facility that is to aggregate the audio and/or visual content of the content units to form one aggregate content unit. The facility that is to aggregate the content units may operate locally, on a computing device operated by a user, or may operate on one or more servers of the interpersonal messaging system. The facility may aggregate the content in any suitable manner, including by creating a sequence of audio and/or visual content that includes the content of the content units in the same order as they were input by the user who created the message. The audio and/or visual content may be aggregated in the sequence such that, when the aggregated content unit is played back, the content of the individual content units is played without any indication (apart from differences in the source audio/visual content itself) that the content originated from two or more different content units. Once the aggregated content unit is created, it may be substituted in the message for the multiple content units and transmitted to one or more recipients of the message. As discussed above, in some embodiments upon receipt of a message a user interface may automatically initiate playback of a received content unit. In such embodiments, upon receipt of an aggregate content unit, the user interface may automatically initiate playback of the aggregate content unit in the same manner and play the audio/visual content, which will result in the audio/visual content of the multiple original content units being played for the receiving user. Presenting the content of the original content units in an automatically-played sequence without breaks between the content may result in a meaning being conveyed to a receiving user that is more than the meanings of the source content units.

Techniques operating according to the principles described herein may be implemented in any suitable manner. Included in the discussion above are a series of flow charts showing the steps and acts of various processes that assist a user with effectively conveying a meaning via digital communication. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

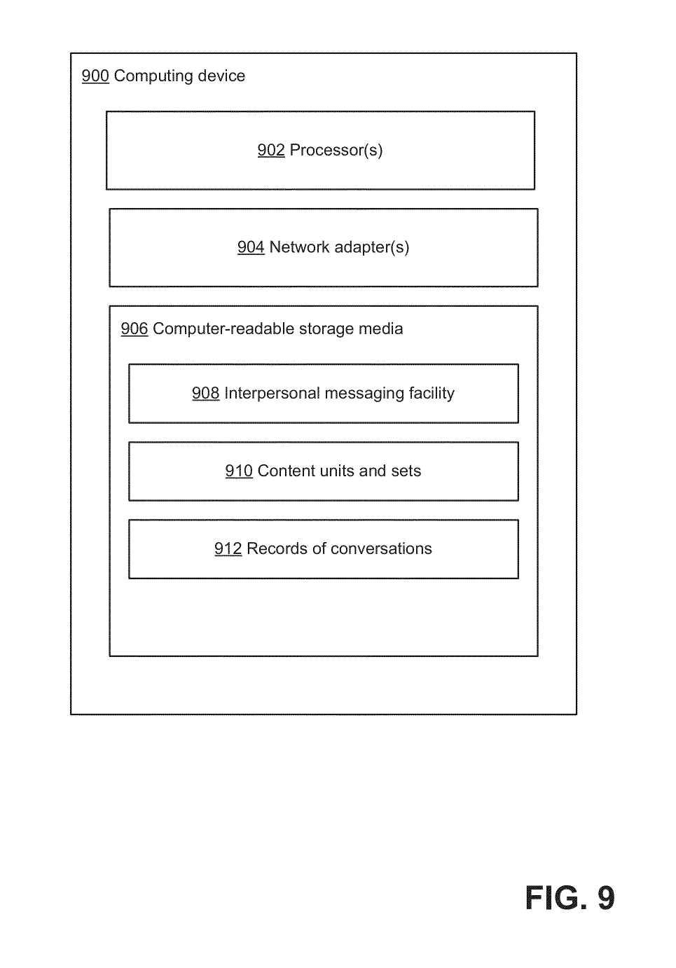

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 906 of FIG. 9 described below (i.e., as a portion of a computing device 900) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 9, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 9 illustrates one exemplary implementation of a computing device in the form of a computing device 900 that may be used in a system implementing techniques described herein, although others are possible. It should be appreciated that FIG. 9 is intended neither to be a depiction of necessary components for a computing device to operate as a transmitting and/or receiving device for use in an interpersonal messaging system in accordance with the principles described herein, nor a comprehensive depiction.

Computing device 900 may comprise at least one processor 902, a network adapter 904, and computer-readable storage media 906. Computing device 900 may be, for example, a desktop or laptop personal computer, a tablet computer, a personal digital assistant (PDA), a smart mobile phone, a server, a wireless access point or other networking element, or any other suitable computing device. Network adapter 904 may be any suitable hardware and/or software to enable the computing device 900 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 906 may be adapted to store data to be processed and/or instructions to be executed by processor 902. Processor 902 is a hardware device that enables processing of data and execution of instructions. The data and instructions may be stored on the computer-readable storage media 906.

The data and instructions stored on computer-readable storage media 906 may comprise computer-executable instructions implementing techniques which operate according to the principles described herein. In the example of FIG. 9, computer-readable storage media 906 stores computer-executable instructions implementing various facilities and storing various information as described above. Computer-readable storage media 906 may store an interpersonal messaging facility 908, which may include software code to perform any suitable one or more of the functions described above. The media 906 may additionally store one or more data structures including data describing content units and sets of content units, including any of the examples of data discussed above. One or more data structures including the records of one or more conversations between users that were carried out using the system may also be stored in the media 906.

While not illustrated in FIG. 9, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method of operating an interpersonal messaging system, the interpersonal messaging system enabling a user to exchange messages with one or more other users in a communication session, at least some of the messages comprising text, the method comprising:
displaying, via a user interface, a keyboard of a set of media content units available for inclusion in messages transmitted via the interpersonal messaging system, each media content unit comprising audio and/or visual content and being associated with at least one unit of metadata describing a content of the media content unit, wherein one or more of the at least one unit of metadata for each media content unit describing the content identifies a concept expressed by the media content unit and/or an emotion to be triggered in a person viewing or listening to the media content unit, and wherein displaying the keyboard comprises displaying an array of images, each image of the array being associated with one of the set of media content units;
in response to a single input of a user indicating one of the array of images of the keyboard, adding a first media content unit corresponding to the indicated one image to a message to be transmitted via the interpersonal messaging system; and
in response to a user input instructing sending of the message, transmitting the message comprising the first media content unit to a computing device operated by a second user.

2. The method of claim 1, wherein:
displaying the keyboard of the set of media content units comprises displaying the keyboard in a screen of a user interface that additionally comprises a user input box for displaying content to be included in the message to be transmitted via the interpersonal messaging system; and
adding the first media content unit to the message comprises displaying the first media content unit in the user input box.

3. The method of claim 1, further comprising:
in response to user input requesting entry of text for inclusion in the message, adjusting display of the keyboard of the set of media content units to display a keyboard of textual characters, wherein adjusting the display of the keyboard comprises replacing each image of the array of images of the keyboard with a textual character of a plurality of textual characters; and
in response to receiving text input, adding the text input to the message to be transmitted via the interpersonal messaging system,
wherein transmitting the message comprises transmitting the message comprising the first media content unit and the text input.

4. The method of claim 1, wherein transmitting the message to the computing device operating by the second user comprises transmitting to a server of the interpersonal messaging system the message and a request that the message be relayed to the second user.

5. The method of claim 1, further comprising:
in response to each one of one or more additional single inputs of the user each indicating an additional image of the array of images of the keyboard, adding to the message one or more additional media content units corresponding to each of the indicated one or more additional images.

6. The method of claim 5, further comprising:
creating one aggregate media content unit from the first media content unit and the one or more additional media content units, the one aggregate media content unit comprising media of the first media content unit and media of the one or more additional media content units ordered in a sequence corresponding to an order in which the user selected the first media content unit and the one or more additional media content units for inclusion in the message.

7. The method of claim 6, wherein transmitting the message comprising the first media content unit comprises transmitting the message comprising the one aggregate media content unit that includes the media of the first media content unit.

8. The method of claim 6, wherein:
the creating the one aggregate media content unit is performed by at least one server of the interpersonal messaging system; and
transmitting the message comprising the first media content unit comprises:
transmitting to the at least one server the message comprising the first media content unit and the one or more additional media content units; and
transmitting from the server to the computing device operated by the second user the message included the one aggregate media content unit.

9. The method of claim 1, further comprising:
receiving text input from the user of at least a part of a word or phrase to be included in the message; and
in response to receiving the text input, searching associated units of metadata for one or more content units to identify content units having content that corresponds to the word or phrase to be included in the message, wherein a result of the searching comprises the set of media content units,
wherein displaying the keyboard of the set of media content units comprises displaying in response to the searching; and
wherein adding the first media content unit to the message comprises substituting the first media content unit for the text input in the message.

10. The method of claim 9, wherein:
receiving the text input comprises receiving a sequence of a plurality of input textual characters; and
searching in response to receiving the text input comprises initiating, in response to receiving each textual character of the sequence, a search based on received textual characters of the sequence.

11. The method of claim 1, wherein:
the set of media content units is a portion of a library of media content units, each media content unit of the library comprising audio and/or visual content and being associated with at least one unit of metadata describing a content of the media content unit, one or more of the at least one unit of metadata for each media content unit identifying a concept expressed by the media content unit and/or an emotion to be triggered in a user viewing or listening to the media content unit;
the method further comprises, in response to receiving input from the user requesting that a filter be applied to the library, identifying media content units satisfying the filter, wherein the set of media content units is at least a portion of the media content units of the library that satisfies the filter; and
wherein displaying the keyboard of the set of media content units comprises displaying in response to the identifying.

12. The method of claim 11, wherein identifying media content units satisfying the filter comprises requesting from a server an identification of media content units satisfying the filter.

13. The method of claim 11, wherein receiving input from the user requesting that the filter be applied comprises receiving a request from the user to view popular media content units, the popular media content units being a number of media content units of the library of media content units that have been exchanged between users of the interpersonal messaging system most often over a time period.

14. The method of claim 11, wherein receiving input from the user requesting that the filter be applied comprises receiving a request from the user to view media content units expressing a particular concept and/or intended to trigger a particular emotion in a person viewing and/or listening to one of the media content units.

15. The method of claim 11, wherein receiving input from the user requesting that the filter be applied comprises receiving a request from the user to view media content units that the user has flagged as preferred by the user.

16. The method of claim 11, wherein:
the library of media content units is a library of media content units that the user has authorization to include in messages to be transmitted via the interpersonal messaging system; and
the method further comprises:
receiving a request from the user to obtain authorization to include additional media content units in messages to be transmitted via the interpersonal messaging system;
displaying to the user a plurality of other media content units for which the user may obtain authorization;
in response to receiving a selection by the user of a second media content unit of the plurality of other media content units and receiving payment from the user for the authorization, storing information indicating that the user has authorization to include the second media content unit in messages.

17. The method of claim 1, wherein:
the set of media content units is a portion of a library of media content units, each media content unit of the library comprising audio and/or visual content and being associated with at least one unit of metadata describing a content of the media content unit, one or more of the at least one unit of metadata for each media content unit identifying a concept expressed by the media content unit and/or an emotion to be triggered in a person viewing or listening to the media content unit;
the method further comprises:
prior to displaying the keyboard of the set of media content units, displaying a keyboard of a second set of media content units, wherein displaying the keyboard of the second set of media content units comprises displaying a second array of second images, each image of the second array being associated with one of the second set of media content units, and wherein each media content unit of the second set of media content units expresses a first concept and/or is intended to trigger a first emotion in a person viewing or listening to the media content unit;
in response to receiving input from the user requesting that a filter be applied to the library to display media content units, the filter being related to a relationship between at least one second concept or emotion and the first concept and/or the first emotion,
identifying, based on the first concept and/or the first emotion and the relationship, the at least one second concept or emotion, and
identifying, for inclusion in the set of media content units, media content units of the library that express one or more of the at least one second concept or emotion; and
displaying the array of images in the keyboard for the set of media content units comprises displaying the array of images in response to the identifying and comprises adjusting the display of the second array of second images to substitute an image of the array of images for each image of the second array of images of the second set.

18. The method of claim 17, wherein:
the relationship, to which the filter relates, that is between the at least one second concept or emotion and the first concept and/or the first emotion is that the at least one second concept or emotion is an opposite concept or emotion as the first concept and/or the first emotion; and
identifying the at least one second concept or emotion comprises determining a concept or emotion that is an opposite concept or emotion as the first concept or first emotion.

19. The method of claim 17, wherein:
the relationship, to which the filter relates, that is between the at least one second concept or emotion and the first concept and/or the first emotion is that the at least one second concept or emotion is intensified form of the first concept and/or the first emotion; and
identifying the at least one second concept or emotion comprises determining a concept or emotion that is an opposite concept or emotion as the first concept or first emotion.

20. The method of claim 1, wherein:
the set of media content units is a portion of a library of media content units, each media content unit of the library comprising audio and/or visual content and being associated with at least one unit of metadata describing a content of the media content unit, one or more of the at least one unit of metadata for each media content unit identifying a concept expressed by the media content unit and/or an emotion to be triggered in a user viewing or listening to the media content unit;
the method further comprises, in response to receiving input from the user requesting that a filter be applied to the library, identifying media content unit satisfying the filter, wherein the set of media content units is at least a portion of the media content units of the library that satisfies the filter, and wherein the filter relates to a producer of audio and/or visual content included in content units; and
wherein displaying the keyboard of the set of media content units comprises displaying in response to the identifying.

21. The method of claim 1, further comprising:
creating the set of media content units based on input from the user, wherein the creating comprises:
receiving a first input from a user requesting creation of the set of media content units;
displaying to a user a library of media content units available for inclusion in the set;
receiving a user selection of a plurality of media content units, from the library of media content units, to include in the set; and
storing information indicating that the plurality of media content units are included in the set of media content.

22. The method of claim 1, further comprising:
creating a new media content unit, wherein the creating comprises:
displaying a plurality of visual content available for inclusion in the new media content unit;
receiving user input indicating a user selection of a first visual content of the plurality of visual content;
receiving from the user first text to include in the new media content unit;
creating the new media content unit including the first text superimposed on at least a portion of the first visual content;
receiving second text identifying a concept expressed by the new media content unit and/or an emotion to be triggered in a person viewing or listening to the new media content unit; and
storing the new media content unit with the second text associated as a unit of metadata for the new media content unit.

23. At least one computer-readable storage medium having encoded thereon executable instructions that, when executed by at least one processor, cause the at least one processor to carry out a method of operating an interpersonal messaging system, the interpersonal messaging system enabling a user to exchange messages with one or more other users in a communication session, at least some of the messages comprising text, the method comprising:
displaying, via a user interface, a keyboard of a set of media content units available for inclusion in messages transmitted via the interpersonal messaging system, each media content unit comprising audio and/or visual content and being associated with at least one unit of metadata describing a content of the media content unit, wherein one or more of the at least one unit of metadata for each media content unit describing the content identifies a concept expressed by the media content unit and/or an emotion to be triggered in a person viewing or listening to the media content unit, and wherein displaying the keyboard comprises displaying an array of images, each image of the array being associated with one of the set of media content units;
in response to a single input of a user indicating one of the array of images of the keyboard, adding a first media content unit corresponding to the indicated one image to a message to be transmitted via the interpersonal messaging system; and
in response to a user input instructing sending of the message, transmitting the message comprising the first media content unit to a computing device operated by a second user.

24. An apparatus:
at least one processor; and
at least one computer-readable storage medium having encoded thereon executable instructions that, when executed by at least one processor, cause the at least one processor to carry out a method of operating an interpersonal messaging system, the interpersonal messaging system enabling a user to exchange messages with one or more other users in a communication session, at least some of the messages comprising text, the method comprising:
displaying, via a user interface, a keyboard of a set of media content units available for inclusion in messages transmitted via the interpersonal messaging system, each media content unit comprising audio and/or visual content and being associated with at least one unit of metadata describing a content of the media content unit, wherein one or more of the at least one unit of metadata for each media content unit describing the content identifies a concept expressed by the media content unit and/or an emotion to be triggered in a person viewing or listening to the media content unit, and wherein displaying the keyboard comprises displaying an array of images, each image of the array being associated with one of the set of media content units;
in response to a single input of a user indicating one of the array of images of the keyboard, adding a first media content unit corresponding to the indicated one image to a message to be transmitted via the interpersonal messaging system; and
in response to a user input instructing sending of the message, transmitting the message comprising the first media content unit to a computing device operated by a second user.
